(19) United States
(12) Patent Application Publication
(10) Pub. No.: US 2010/0105412 A1
(43) Pub. Date: Apr. 29, 2010

(54) Apparatus and method for providing position information in a mobile communication system

(75) Inventors: Young-Min Won, Suwon-si (KR); Nam-Hoon Kim, Suwon-si (KR); Jae-Ho Kim, Seoul (KR); Woo-Jun Choi, Suwon-si (KR); Dae-Hyun Sim, Seoul (KR); Beom-Soo Cho, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/589,354

(22) Filed: Oct. 22, 2009

(30) Foreign Application Priority Data
Oct. 23, 2008 (KR) 10-2008-0103976
Jun. 5, 2009 (KR) 10-2009-0049713

(51) Int. Cl. H04W 64/00

(52) U.S. Cl. 455/456.1

(57) ABSTRACT

A method and an apparatus for providing position information in a mobile communication system includes setting, at a mobile communication terminal which requests to provide the position information, a position condition to provide the position information. The mobile communication terminal generates a message including the position condition, and sends the generated message to a correspondent terminal of which the position information is to be acquired. The mobile communications terminal also receives a position information request message including the position condition from a correspondent terminal, determines whether the position condition is violated or not by periodically acquiring its position information, and sends a message informing of the position information violation to the correspondent terminal when the position condition is violated.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Oct. 23, 2008 and assigned Serial No. 10-2008-0103976 and a Korean patent application filed in the Korean Intellectual Property Office on Jun. 5, 2009 and assigned Serial No. 10-2009-0049713, the entire disclosure of which is hereby incorporated by reference.

### TECHNICAL FIELD OF THE INVENTION

The present invention relates generally to an apparatus and a method for providing position information in a mobile communication system. More particularly, the present invention relates to an apparatus and a method for informing a correspondent mobile communication terminal of position information of a particular mobile communication terminal by transmitting and receiving messages between the mobile communication terminals.

### BACKGROUND OF THE INVENTION

The use of mobile communication terminals is rapidly increasing due to their handy portability. To draw more users, service providers (terminal manufacturers) competitively develop terminals with far more convenient functions. For example, as crimes, such as kidnapping and abduction, are frequent these days, the mobile communication terminal provides an emergency paging service or a positioning service to the user against emergencies.

In regards to the positioning service, a mobile communication provider network receives a positioning request from a user terminal, tracks the position of the other user terminal, and informs the user of the obtained location. That is, when the user wants to know the location of another user, the user accesses the mobile communication provider network which provides the positioning service, inputs information of the terminal of the other user, is authenticated to track the position of the other user, and thus receives the current position of the other user from the mobile communication provider network. Representative examples of the positioning service include a friend searching service or a missing child searching service.

As discussed above, the conventional positioning service detects the location of the target terminal over the mobile communication network and informs the terminal requesting the positioning of the detected location. In other words, the conventional positioning service incurs the additional cost for the mobile communication network access, and the user needs to continuously access the positioning service in some cases to detect the location of the target terminal. For example, to know the location of the child when the child goes to school or comes back from school, the parent has to access the corresponding service constantly, in real time, and receive the position information of his/her child.

### SUMMARY OF THE INVENTION

To address the above-discussed deficiencies of the prior art, it is a primary aspect of the present invention is to address at least the above mentioned problems and/or disadvantages and to provide at least the advantages described below. Accordingly, an aspect of the present invention is to provide a method and an apparatus for providing position information in a mobile communication system.

Another aspect of the present invention is to provide a method and an apparatus for providing position information independent of a mobile communication provider by transmitting and receiving messages between mobile communication terminals.

Yet another aspect of the present invention is to provide an apparatus and a method for a particular mobile communication terminal to set a position condition of the other mobile communication terminal, to send a message including the position condition to the other mobile communication terminal, and to recognize violation of the position condition of the other mobile communication terminal when it violates the position condition.

Still yet another aspect of the present invention is to provide an apparatus and a method for a mobile communication terminal to periodically receive position information of a target mobile communication terminal.

A further aspect of the present invention is to provide an apparatus and a method for a mobile communication terminal to display position and distance information of a target mobile communication terminal so that a user can intuitively perceive the information.

According to one aspect of the present invention, a method for a mobile communication terminal requesting to provide position information includes generating a message comprising a position condition for a correspondent terminal; sending the generated message to the correspondent terminal; and receiving a message indicating whether the position condition is violated, from the correspondent terminal.

According to another aspect of the present invention, a method of a mobile communication terminal requested to provide position information includes receiving a message comprising a position condition from a correspondent terminal; determining whether the position condition is violated by periodically acquiring position information of the terminal; and sending a message indicating whether the position condition is violated to the correspondent terminal.

According to yet another aspect of the present invention, an apparatus of a mobile communication terminal requesting to provide position information includes a controller for generating a message comprising a position condition for a correspondent terminal; and a transceiver for sending the generated message to the correspondent terminal under the control of the controller and receiving a message indicating whether the position condition is violated, from the correspondent terminal.

According to still yet another aspect of the present invention, an apparatus of a mobile communication terminal requested to provide position information includes a transceiver for receiving a message comprising a position condition from a correspondent terminal; a Global Positioning System (GPS) receiver for acquiring position information of the terminal; and a controller for determining whether the position condition is violated by periodically acquiring the position information of the terminal through the GPS receiver, and controlling the transceiver to send a message indicating whether the position condition is violated to the correspondent terminal.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a mobile communication terminal according to an exemplary embodiment of the present invention;

FIG. 2 illustrates signaling transmitted and received between mobile communication terminals to provide a position information service according to an exemplary embodiment of the present invention;

FIG. 3 illustrates operations of a tracer terminal which tracks the position according to an exemplary embodiment of the present invention;

FIGS. 4A and 4B illustrate operations of a target terminal according to an exemplary embodiment of the present invention;

FIGS. 5A and 5B illustrate messages for providing the position information service according to an exemplary embodiment of the present invention;

FIGS. 6A and 6B illustrate screen views for setting a position condition of the target terminal at the tracer terminal according to an exemplary embodiment of the present invention;

FIGS. 7A and 7B illustrate screen views of the position condition at the target terminal according to an exemplary embodiment of the present invention;

FIGS. 8A and 8B illustrate screen views informing of violation of the position condition at the target terminal according to an exemplary embodiment of the present invention;

FIGS. 9A and 9B illustrate screen views informing of the position condition violation of the target terminal at the tracer terminal according to an exemplary embodiment of the present invention;

FIG. 10 illustrates a screen view for setting the position tracking function for the target terminal at the tracer terminal according to an exemplary embodiment of the present invention; and

FIGS. 11A, 11B and 11C illustrate screen views of the position of the target terminal at the tracer terminal according to an exemplary embodiment of the present invention.

Throughout the drawings, like reference numerals will be understood to refer to like parts, components and structures.

### DETAILED DESCRIPTION OF THE INVENTION

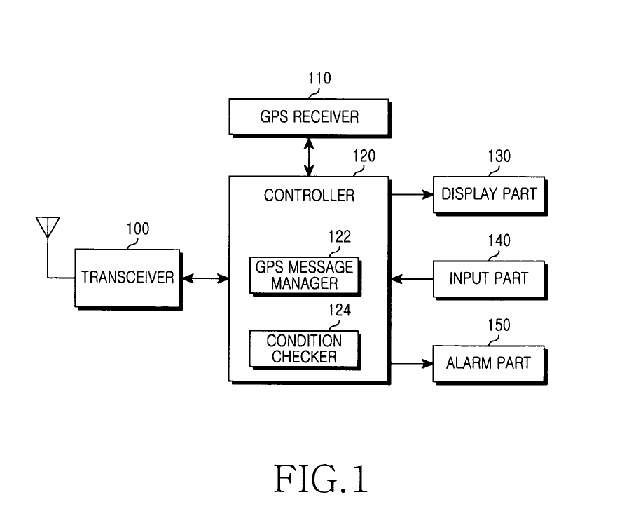

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

Exemplary embodiments of the present invention provide a method and an apparatus for a particular mobile communication terminal to send a message including a position condition to a target mobile communication terminal and for the target mobile communication terminal to inform the particular mobile communication terminal of its violation of the position condition.

FIG. 1 illustrates a block diagram of a mobile communication terminal according to an exemplary embodiment of the present invention. Hereinafter, the mobile communication terminal can be a cellular phone, personal communication system, personal digital assistant, and International Mobile Telecommunication (IMT) 2000 terminal. The following explanations adopt a general structure of those terminals.

The terminal of FIG. 1 includes a transceiver 100, a Global Positioning System (GPS) receiver 110, a controller 120, a display part 130, an input part 140, and an alarm part 150. The controller 120 includes a GPS message manager 122 and a condition checker 124.

The transceiver 100 can send and receive radio signals of input and output data via an antenna. According to an exemplary embodiment of the present invention, the transceiver 100 sends and receives messages for a position information service to and from the other terminal under the control of the controller 120.

The GPS receiver 110 can receive a radio wave from a GPS satellite and acquire position information of the mobile communication terminal. Under the control of the controller 120, the GPS receiver 110 can acquire the position information by periods and can provide the acquired position information to the controller 120.

The controller 120 can control operations of the mobile communication terminal. More specifically, when an event for monitoring or warning of a position of a particular terminal is generated, the controller 120 can set a position condition (for example, start time, end time, and movement radius) for the particular terminal, the controller 120 can generate a message including the position condition, and transmit the message to the particular terminal. When receiving a message including the position condition from the other terminal, the controller 120 can examine whether the position condition of the message is violated, and can inform the other terminal of the condition violation.

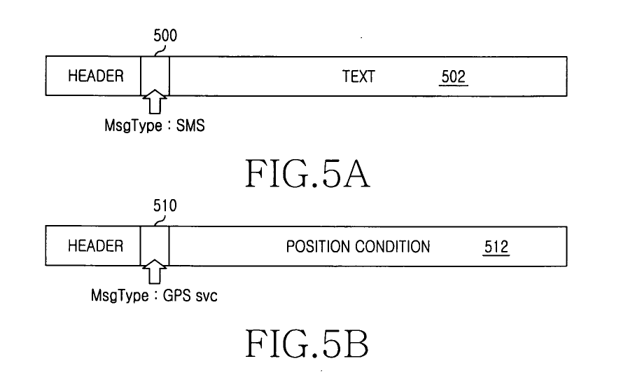

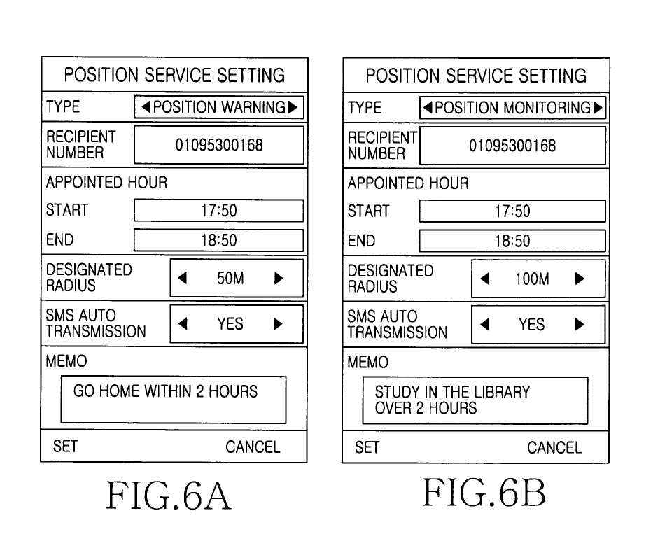

The controller 120 can set a type of the message including the position condition of the particular terminal to the GPS service through the GPS message manager 122. To do so, the present invention defines and utilizes the message type for the position information service in addition to the existing message type. For example, a Short Message Service (SMS) message including a general text 502 is set to the SMS 500 in FIG. 5, the message type including the position condition 512 is set to the GPS Service (SVC) 510. Herein, the message of the GPS SVC type includes information relating to a service type, an appointed hour, a designated radius, an SMS automatic transmission setting, and a memo as the position conditions as shown in FIG. 6. The service type can include a position monitoring service to prevent the target terminal from leaving out of the designated radius during the appointed hour, and a position warning service for making the target terminal leave out of the designated radius within the appointed hour. The appointed hour indicates a start time and an end time of the position monitoring or warning. The designated radius indicates the range of the target terminal to keep or to egress according to the service type. The SMS automatic transmission setting indicates whether or not to automatically inform the tracer terminal which monitors or warns of the violation when the target terminal violates the condition of the designated radius during the appointed hour.

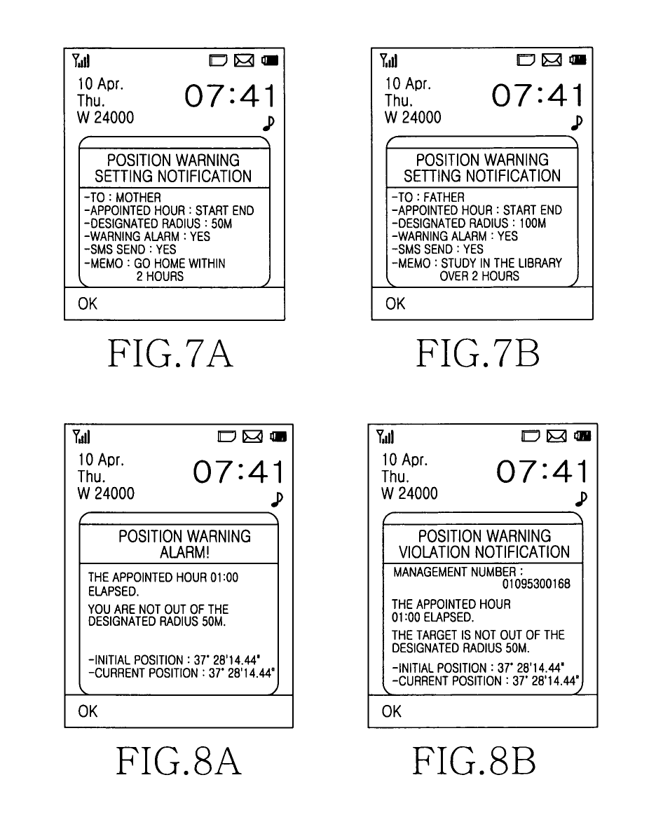

The controller 120 can check the type of the message received from the other terminal at the GPS message manager 122, and can acquire the position condition by analyzing the corresponding message when the message type is the GPS SVC type. For example, the GPS message manager 122 can obtain the position condition as shown in FIG. 7 by analyzing the message.

At the condition checker 124, the controller 120 can determine whether the acquired position condition is violated. More specifically, the controller 120 obtains the position information of the terminal from the GPS receiver 110 and examines whether or not the terminal leaves out of the designated radius for the appointed hour. When the position condition is violated according to the examination result, the controller 120 can control the display part 130 or the alarm part 150 to warn the user of the position condition violation, and can send a message informing of the violation to the other terminal. Herein, when the position condition is violated, the controller 120 can receive a message requesting to periodically report of the position from the terminal which sends the position condition via the transceiver 100. Thus, the controller 120 periodically acquires its position information through the GPS receiver 110 and transmits the position information to the terminal which requests the position report. In so doing, the controller 120 determines whether the position monitoring is allowed to the terminal requesting the position report, periodically transmits its position information only when the position monitoring is allowed, and sends a message informing of no position report to the corresponding terminal when the position monitoring is not allowed. Herein, whether to allow the position monitoring can be set and edited by the user.

When receiving the message informing of the violation from the other terminal, the controller 120 can check a user setting indicative of whether to track the position of the other terminal. Upon confirming the position tracking, the controller 120 can send a message requesting to periodically report of the position to the other terminal. When receiving the position information from the other terminal on the periodic basis, the controller 120 analyzes the position information and displays the analyzed position information through the display part 130. The controller 120 can calculate a distance and a direction between the two terminals using the position information of the terminal and the position information of the other terminal or calculate a distance and a direction between the other terminal and the designated radius of the position condition so that the user of the terminal can intuitively recognize the position of the other terminal, and then control to display the calculated information on the display part 130. Herein, the distance information between the two terminals or the distance information between the other terminal and the designated radius can be displayed at a terminal having no map function.

The display part 130 can display status information of the mobile communication terminal, numbers and characters, videos, and still images, can display a position condition input window under the control of the controller 120, and can display the analyzed position condition. The display part 130 can display the message warning of the position condition violation under the control of the controller 120, and can display the message informing that the target terminal violates the position condition. Under the control of the controller 120, the display part 130 can display the position information of the terminal, the position information of the target terminal monitored or warned, the distance and the direction information between the two terminals, and the distance and the direction information between the target terminal and the designated radius set as the position condition.

The input part 140 provides key input data corresponding to a key pressed by the user to the controller 120. In particular, the input part 140 can receive the position condition from the user and provides the position information to the controller 120.

The alarm part 150 can activate the alarm or the vibration preset to warn the position condition violation under the control of the controller 120.

In the above explanations, the target terminal monitored or warned may not include the GPS receiver.

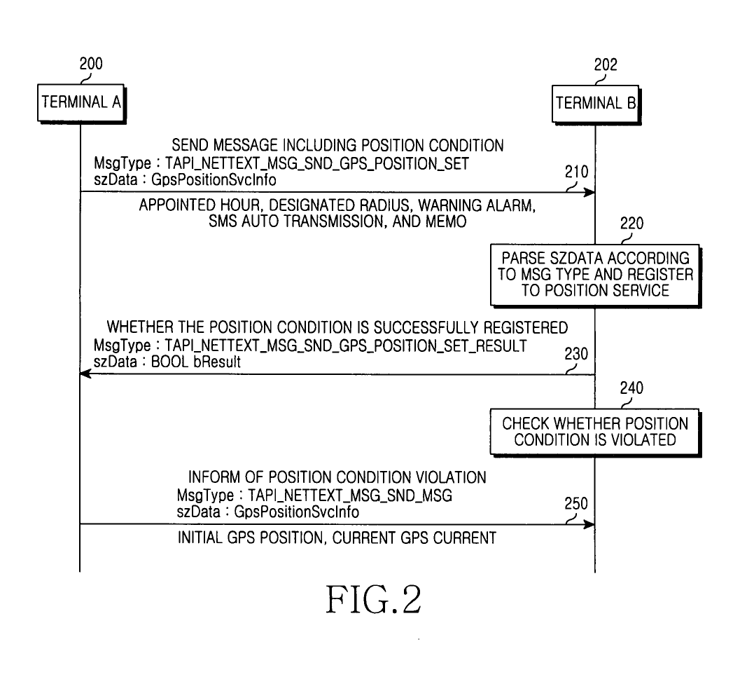

FIG. 2 illustrates signaling transmitted and received between the mobile communication terminals to provide the position information service according to an exemplary embodiment of the present invention.

To monitor or warn the position of the terminal B 202, the terminal A 200 generates the GPS SVC type message including the position condition of the terminal B 202 and sends the generated message to the terminal B 202 in step 210. Herein, the GPS SVC type message can include the information relating to the service type, the appointed hour, the designated radius, the SMS automatic transmission setting, and the memo as the position conditions as shown in FIG. 6.

Receiving the message from the terminal A 200, the terminal B 202 confirms that the received message type is the GPS SVC type, acquires the position condition by analyzing the message, and registers the position condition to provide the position service in step 220. In step 230, the terminal B 202 sends a signal indicating whether the position condition is successfully registered, to the terminal A 200.

Next, the terminal B 202 can examine whether the position condition is violated or not. More particularly, the terminal B 202 examines whether or not the terminal leaves out of the designated radius for the appointed hour by periodically acquiring its position information through the GPS receiver. When the position condition is violated, the terminal B 202 sends the message regarding the position condition violation to the terminal A 200. The message regarding the position condition violation can be an SMS type message or a GPS SVC type message, and can include initial position information and current position information of the terminal B 202.

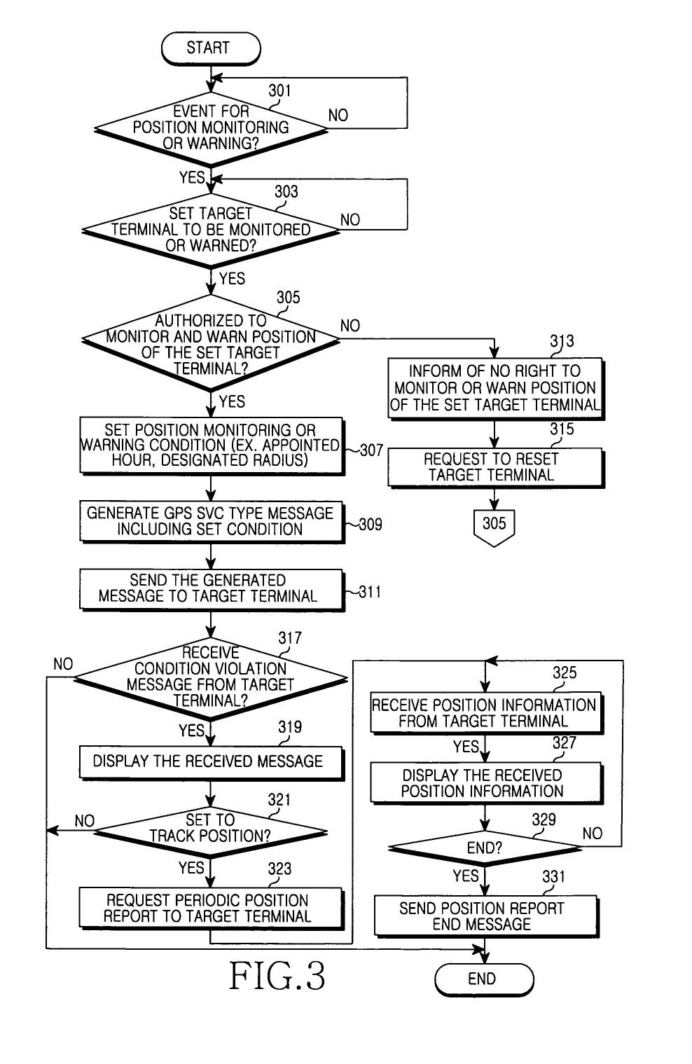

FIG. 3 illustrates operations of the tracer terminal according to an exemplary embodiment of the present invention.

In step 301, the tracer terminal determines whether the event for monitoring or warning the position of the other terminal is generated or not. When the event is generated, the tracer terminal determines whether the target terminal to be monitored or warned is set in step 303. For example, the tracer terminal checks whether a phone number of the target terminal is directly input or the target terminal is selected in a phone book.

When the target terminal is set, the tracer terminal checks whether it has the right to monitor or warn the position of the set terminal in step 305. The right to monitor or warn the position can be acquired by transmitting and receiving separate messages for requesting the authority, and obtained typically in various methods used for the mutual authentication between the terminals.

When having no authority, the tracer terminal displays a message informing of no authority to monitor or warn the position of the set target terminal in step 313, displays a message requesting to reset the target terminal in step 315, and returns to step 305.

When having the authority, the tracer terminal sets the condition for monitoring or warning the position by displaying the position condition input window as shown in FIG. 6 in step 307. Herein, the condition for monitoring or warning the position should include at least one of the service type, the appointed hour, the designated radius, the SMS automatic transmission setting, and the memo information.

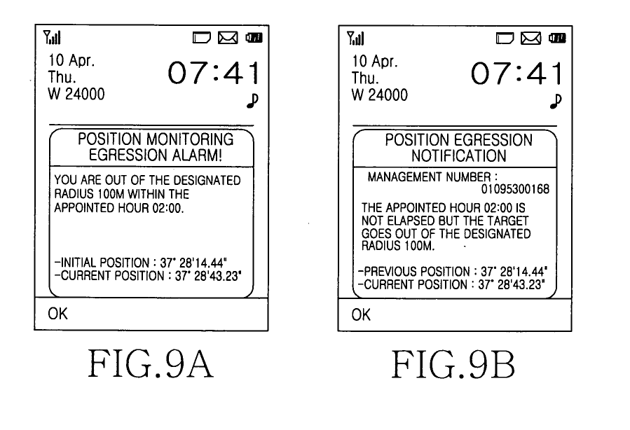

Next, the tracer terminal generates the GPS SVC type message including the set condition in step 309, sends the generated message to the set target terminal in step 311, and determines whether the condition violation message is received from the target terminal in step 317. For example, the tracer terminal checks whether the message indicative of the position condition violation of the set terminal of FIG. 8B or FIG. 9B is received or not.

When not receiving the condition violation message, the tracer terminal finishes this process. When receiving the condition violation message, the tracer terminal displays the received message in step 319.

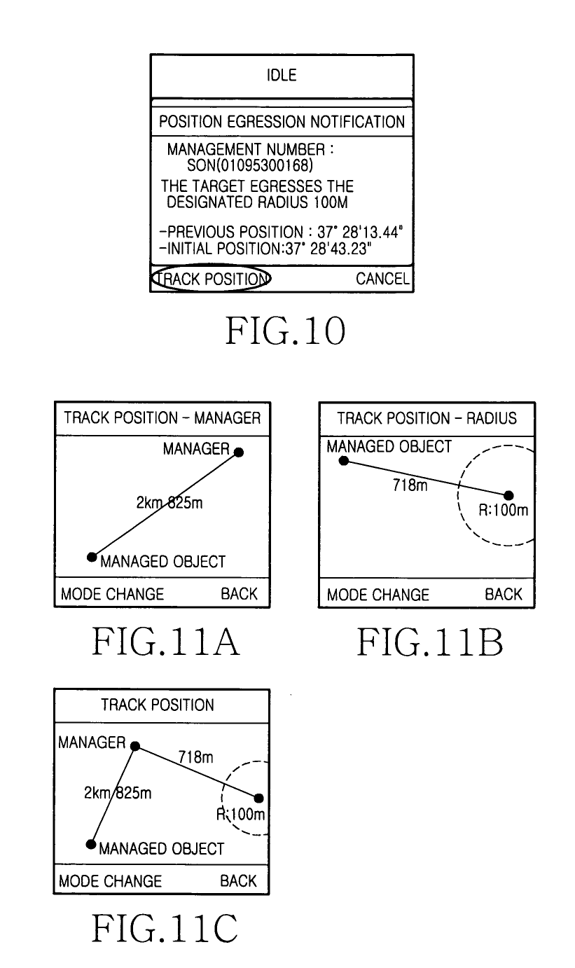

In step 321, the tracer terminal examines whether the user sets the position tracking function. For example, the terminal examines whether a menu for tracking the position of the target terminal is selected as shown in FIG. 10. Herein, the position tracking function, which is a function for tracking the position of the target terminal violating the condition in real time, can commence or end according to the user's setting.

When the position tracking function is not set, the tracer terminal finishes this process. When the position tracking function is set, the tracer terminal sends the message requesting to periodically report of the position to the target terminal in step 323.

Next, the tracer terminal receives the position information from the target terminal in step 325 and displays the received position information on the screen in step 327. The tracer terminal can display merely coordinate information of the position of the target terminal on the screen, or the distance and the direction between the tracer terminal and the target terminal or the distance and the direction between the target terminal and the designated radius on the screen so that the user of the terminal can intuitively recognize the position of the target terminal. For example, the tracer terminal can display that the managed object, which is the target terminal, is away from the manager, which is the tracer terminal, to the northeast by 2 km 825 m as shown in FIG. 11A, or that the managed object, which is the target terminal, is away from the designated radius northwest by 718 m as shown in FIG. 11B. The tracer terminal may display which direction and how far the managed object is away from the manager and the designated radius as shown in FIG. 11C. Herein, the distance information and the direction can be obtained from the coordinates indicative of the position information. Such a function can be executed in a terminal that does not include a map function. The terminal with the map function is able to display the positions of the terminal, the target terminal, and the designated radius and their distance information on the map.

In step 329, the tracer terminal determines whether the position tracking function of the target terminal is ended. When the position tracking function does not end, the tracer terminal goes back to step 325. When the position tracking function ends, the tracer terminal sends a message indicative of the termination of the position report to the target terminal in step 331 and then finishes this process.

While the tracer terminal executes the position tracking function on the target terminal after receiving the message informing of the condition violation from the target terminal, the tracer terminal may perform the position tracking function on the target terminal without receiving the message informing of the condition violation.

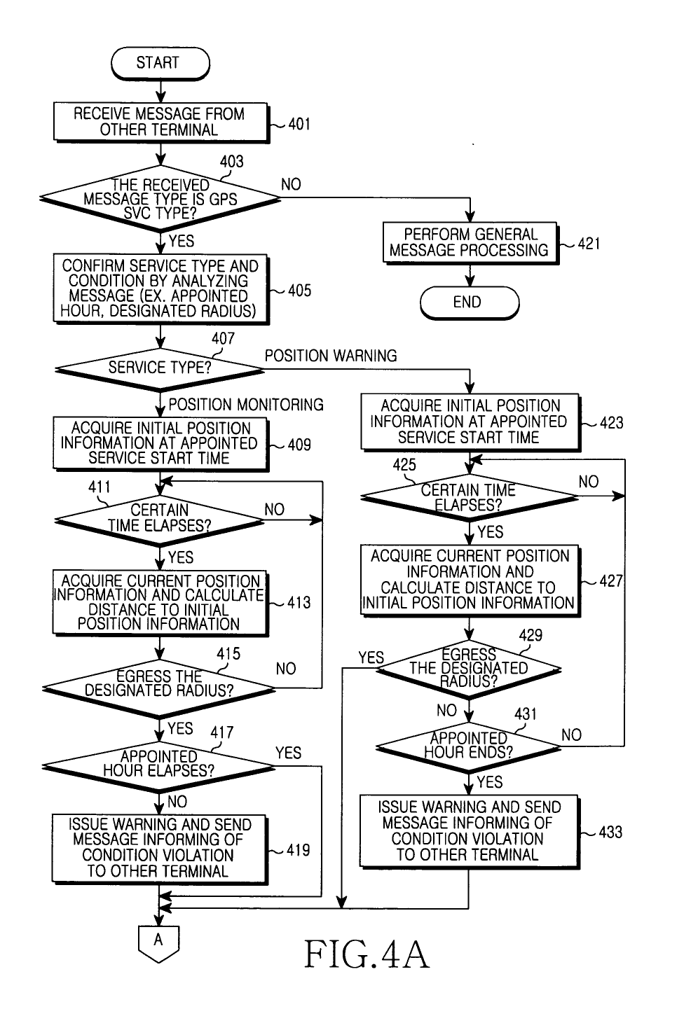

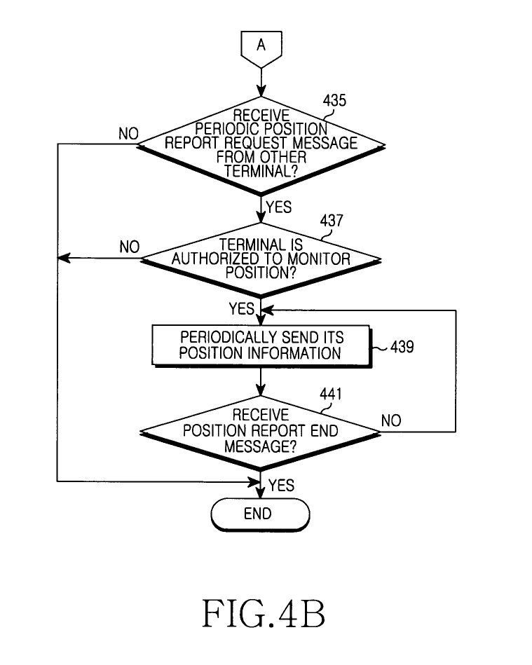

FIGS. 4A and 4B illustrate operations of the target terminal according to an exemplary embodiment of the present invention.

The target terminal receives the message from the other terminal in step 401 and determines whether the received message type is the GPS SVC type in step 403. When the received message type is not the GPS SVC type, the target terminal performs a general message processing on the received message in step 421 and then finishes this process.

When the received message type is the GPS SVC type, the target terminal confirms the service type and the other position conditions for the position monitoring or warning by analyzing the message in step 405. Herein, the condition for the position monitoring or warning should include at least one of the service type, the appointed hour, the designated radius, the SMS automatic transmission setting, and the memo information. When the received message type is the GPS SVC type, the target terminal can confirm the service type and the position conditions by analyzing the message and display the confirmed information as shown in FIG. 7 to notify that the other terminal; that is, the tracer terminal requests the position monitoring or warning service.

In step 407, the target terminal determines whether the service type is the position monitoring or the position warning. Herein, the position monitoring service blocks the target terminal from leaving out of the designated radius for the appointed hour, and the position warning service makes the target terminal to leave out of the designated radius within the appointed hour.

When the service type is the position warning service, the target terminal acquires the initial position information at the appointed service start time in step 423. That is, the target terminal acquires its position information through the GPS receiver at the start time by checking the service start time in the position condition. Next, the target terminal determines whether a certain time elapses in step 425. When the certain time passes by, the target terminal acquires its current position information and calculates the distance to the initial position information in step 427.

In step 429, the target terminal determines whether the calculated distance exceeds the designated radius of the position condition. When the calculated distance exceeds the designated radius, the target terminal proceeds to step 435. By contrast, when the calculated distance does not exceed the designated radius, the target terminal determines whether the appointed hour of the position condition ends; that is, whether the end time of the position condition elapses in step 431. When the appointed hour does not end, the target terminal returns to step 425. When the appointed hour ends, the target terminal issues the warning message or the warning alarm and sends a message informing of the position condition violation to the tracer terminal in step 433. More specifically, when the target terminal does not egress the designated radius within the appointed hour, the target terminal displays the warning message to its user as shown in FIG. 8A and sends a message of FIG. 8B to the other user who requests the position warning service. The warning message and the message informing of the position condition violation can include the initial position information and the current position information as shown in FIGS. 8A and 8B.

Next, the target terminal goes to step 435.

When the service type is the position monitoring service, the target terminal obtains the initial position information at the appointed service start time in step 409. That is, the target terminal acquires its position information through the GPS receiver at the start time by checking the service start time in the position condition. Next, the target terminal checks whether a certain time passes by in step 411. When the certain time elapses, the target terminal acquires its current position information and calculates the distance to the initial position information in step 413.

In step 415, the target terminal determines whether the calculated distance exceeds the designated radius of the position condition. When the calculated distance does not exceed the designated radius, the target terminal goes back to step 411. When the calculated distance exceeds the designated radius, the target terminal determines whether the appointed hour of the position condition ends or not; that is, whether the end time of the position condition elapses or not in step 417. When the appointed hour ends, the target terminal proceeds to step 435. When the appointed hour does not end, the target terminal issues the warning message or the warning alarm and sends a message informing of the position condition violation to the tracer terminal in step 419. More specifically, when the target terminal leaves out of the designated radius within the appointed hour, it displays the warning message of FIG. 9A to its user and sends the message of FIG. 9B to the other user who requests the position warning message. The warning message and the message informing of the position condition violation can include the initial position information and the current position information as shown in FIGS. 9A and 9B.

In step 435, the target terminal determines whether the message requesting the periodic report of the position is received from the tracer terminal. When receiving no message requesting the periodic position report from the tracer terminal, the target terminal finishes this process.

Upon receiving the message requesting the periodic position report from the tracer terminal, the target terminal examines whether the tracer terminal requesting the periodic position report is authorized to monitor its position in step 437. Herein, whether to authorize the terminal to monitor the position can be set and edited by the user. When the tracer terminal is not authorized to monitor the position of the target terminal, the target terminal finishes this process.

Alternatively, when the tracer terminal is authorized to monitor the position of the target terminal, the target terminal periodically transmits its position information to the tracer terminal in step 439. In step 441, the target terminal determines whether a position report end message is received. When not receiving the position report end message, the target terminal goes back to step 439. When receiving the position report end message, the target terminal finishes this process.

As such, the particular mobile communication terminal sends the message including the position condition to the target mobile communication terminal. When the target mobile communication terminal violates its position condition, it informs the particular mobile communication terminal of the violation. Thus, the position information service independent of the mobile communication provider network can be provided. Since the target mobile communication terminal informs the particular mobile communication terminal of its violation when it violates the position condition, there is no need to periodically check the position of the target mobile communication terminal. By predicting the movement of the target mobile communication terminal, accidents or troubles can be prevented in advance. When the target mobile communication terminal violates the position condition, the position of the target mobile communication terminal is traced and displayed in real time so that how far the target mobile communication terminal goes out of the designated range can be determined with ease.

While the invention has been shown and described with reference to certain exemplary embodiments thereof, it will be understood by those skilled in the art that various changes in form and details may be made therein without departing from the spirit and scope of the invention as defined by the appended claims and their equivalents.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of a mobile communication terminal requesting to provide position information, the method comprising:
generating a message comprising a position condition for a correspondent terminal;
sending the generated message to the correspondent terminal; and
receiving a message indicating whether the position condition is violated, from the correspondent terminal.

2. The method of claim 1, wherein the position condition comprises at least one of a service type, an appointed time, a designated radius, a Short Message Service automatic transmission setting, and memo information.

3. The method of claim 1, wherein the message comprising the position condition is a message requesting to provide the position information using a message type.

4. The method of claim 1, further comprising:
requesting the correspondent terminal to periodically provide the position information;
periodically receiving the position information of the correspondent terminal; and
calculating and displaying a distance and a direction of the correspondent terminal with respect to the terminal using the position information of the correspondent terminal and position information of the terminal.

5. The method of claim 4, further comprising:
calculating and displaying a distance and a direction of the correspondent terminal with respect to a designated radius of the position condition.

6. A method of a mobile communication terminal requested to provide position information, the method comprising:
receiving a message comprising a position condition from a correspondent terminal;
determining whether the position condition is violated by periodically acquiring position information of the terminal; and
sending a message indicating whether the position condition is violated to the correspondent terminal.

7. The method of claim 6, wherein the position condition comprises at least one of a service type, an appointed time, a designated radius, a Short Message Service automatic transmission setting, and memo information.

8. The method of claim 6, further comprising:
when the position condition is violated, displaying a message informing of the position condition violation or producing a warning sound.

9. The method of claim 6, wherein determining whether the position condition is violated by periodically acquiring the position information of the terminal comprises:
when the service type is a position warning service and the terminal does not leave out of the designated radius within the appointed hour, determining that the position condition is violated; and
when the service type is a position monitoring service and the terminal leaves out of the designated radius within the appointed hour, determining that the position condition is violated.

10. The method of claim 6, further comprising:
receiving a message requesting a periodic position report from the correspondent terminal;
determining whether the correspondent terminal is authorized to monitor the position of the terminal; and
periodically transmitting position information of the terminal to the correspondent terminal.

11. An apparatus for use in a mobile communication terminal capable of requesting to provide position information, the apparatus comprising:
a controller configured to generate a message comprising a position condition for a correspondent terminal; and
a transceiver configured to send the generated message to the correspondent terminal under the control of the controller and further configured to receive a message from the correspondent terminal, the message indicating whether the position condition is violated.

12. The apparatus of claim 11, wherein the position condition comprises at least one of a service type, an appointed time, a designated radius, a Short Message Service automatic transmission setting, and memo information.

13. The apparatus of claim 11, wherein the message comprising the position condition is a message requesting to provide the position information using a message type.

14. The apparatus of claim 11, wherein the controller requests the correspondent terminal to periodically provide the position information, periodically receives the position information of the correspondent terminal through the transceiver, and calculates a distance and a direction of the correspondent terminal with respect to the terminal using the position information of the correspondent terminal and position information of the terminal, further comprising:
a display part configured to display the distance and the direction calculated at the controller.

15. The apparatus of claim 14, wherein the controller calculates a distance and a direction of the correspondent terminal with respect to a designated radius of the position condition.

16. An apparatus of a mobile communication terminal requested to provide position information, the apparatus comprising:
a transceiver configured to receive a message comprising a position condition from a correspondent terminal;
a Global Positioning System (GPS) receiver configured to acquire position information of the terminal; and
a controller configured to determine whether the position condition is violated by periodically acquiring the position information of the terminal through the GPS receiver, and configured to control the transceiver to send a message indicating whether the position condition is violated to the correspondent terminal.

17. The apparatus of claim 16, wherein the position condition comprises at least one of a service type, an appointed time, a designated radius, a Short Message Service automatic transmission setting, and memo information.

18. The apparatus of claim 16, further comprising:
a display part configured to, when the position condition is violated, display a message informing of the position condition violation under control of the controller; and
an alarm part configured to produce a warning sound notifying the position condition violation under the control of the controller.

19. The apparatus of claim 16, wherein, when the service type is a position warning service and the terminal does not leave out of the designated radius within the appointed hour, the controller determines that the position condition is violated, and
when the service type is a position monitoring service and the terminal leaves out of the designated radius within the appointed hour, the controller determines that the position condition is violated.

20. The apparatus of claim 16, wherein the controller determines whether the correspondent terminal is authorized to monitor the position of the terminal when receiving a message requesting a periodic position report from the correspondent terminal, and controls a function to periodically transmit the position information of the terminal to the correspondent terminal.
